(19) United States
(12) Patent Application Publication
(10) Pub. No.: US 2020/0230637 A1
(43) Pub. Date: Jul. 23, 2020

(54) Sprinkler Sleeve Attachment

(71) Applicant: Saiid Nachawi, West Palm Beach, FL (US)

(72) Inventor: Saiid Nachawi, West Palm Beach, FL (US)

(21) Appl. No.: 16/393,012

(22) Filed: Apr. 24, 2019

Related U.S. Application Data
(60) Provisional application No. 62/795,286, filed on Jan. 22, 2019.

(51) Int. Cl. B05B 15/622

(52) U.S. Cl. CPC B05B 15/622

(57) ABSTRACT

A sprinkler sleeve attachment for easily installing or replacing an in-ground sprinkler head when needed. The sprinkler sleeve attachment includes a tubular, rigid body having an open upper end and an open, tapered lower end. The sprinkler sleeve attachment further includes an internal connection member and an external connection member wherein the internal connection member is a threaded male adaption for receiving a sprinkler head thereon in liquid communication and the external connection member is a threaded female adaption disposed on the open lower end configured to receive an end of a water connection hose therein. A plurality of stabilizing fins extends orthogonally outward from an exterior surface of the tubular body wherein the stabilizing fins are oriented along a longitudinal axis thereof.

### CROSS REFERENCE TO RELATED APPLICATIONS

This application claims the benefit of U.S. Provisional Application No. 62/795,286 filed on Jan. 22, 2019. The above identified patent application is herein incorporated by reference in its entirety to provide continuity of disclosure.

### BACKGROUND OF THE INVENTION

The present invention relates to sprinkler sleeve attachments. More specifically, the present invention relates to a sprinkler sleeve attachment for a sprinkler head including an interior male connector configured to receive a sprinkler body, an exterior female connector configured to connect to a main water line, and a plurality of lengthwise stabilizing fins disposed on an exterior surface of the sleeve.

Replacing sprinklers can be an immensely difficult task for homeowners and groundskeepers. People are forced to dig holes and trenches in their yards to reach the water main and then must clear away any dirt and debris to prevent a contamination with the water source. The entire process is frustrating and can take a considerable amount of time to complete, especially if more than one sprinkler head needs changing. If a sprinkler head is damaged or broken, the process of digging the connection line up must be done again to expose the area so that the sprinkler head can be taken off and replaced. A more convenient method for quickly and easily changing sprinkler heads is needed.

Devices have been disclosed in the known art that relate to sprinkler attachments and fluid spray terminals. These include devices that have been patented and published in patent application publications. These devices, however, fail to disclose all the elements of the present invention.

In light of the devices disclosed in the known art, it is submitted that the present invention substantially diverges in design elements from the known art and consequently it is clear that there is a need in the art for an improvement to existing sprinkler head attachments. In this regard, the instant invention substantially fulfills these needs.

### SUMMARY OF THE INVENTION

In view of the foregoing disadvantages inherent in the known types of fluid spray terminals and housing attachments now present in the known art, the present invention provides a sprinkler sleeve attachment wherein the same can be utilized for providing convenience for the user when quickly and easily replacing a damaged sprinkler head without having to dig up the yard.

It is therefore an object of the present invention to provide a new and improved sprinkler sleeve attachment that has all of the advantages of the known art and none of the disadvantages.

It is another object of the present invention to provide a sprinkler sleeve attachment that comprises a unitary body having an open upper end and a tapered, open lower end defining a channel therethrough, wherein the open lower end has a diameter smaller than that of the open upper end, an internal connection member is located within the interior volume of the unitary volume while an exterior connection member is disposed on the open lower end, and a plurality of stabilizing fins run longitudinally along an exterior surface of the unitary body.

Another object of the present invention is to provide a sprinkler sleeve attachment wherein the unitary body is comprised of a rigid construction having a circular cross-sectional area.

Yet another object of the present invention is to provide a sprinkler sleeve attachment wherein the internal connection member comprises a threaded male adapter configured to removably receive a sprinkler head thereon while the external connection member comprises a threaded female adapter configured to removably receive a water connection line therein.

Still another object of the present invention is to provide a sprinkler sleeve attachment wherein the plurality of stabilizing fins comprises planar protrusions extending outwardly from an exterior surface of the unitary body and includes a taper descending toward the open lower end.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the sprinkler sleeve attachment.

FIG. 2 shows a side view of an embodiment of the sprinkler sleeve attachment.

FIG. 3 shows a cross-sectional view of an embodiment of the sprinkler sleeve attachment.

FIG. 4 shows an overhead view of an embodiment of the sprinkler sleeve attachment.

FIG. 5 shows a perspective view of an embodiment of the sprinkler sleeve attachment in use.

### DETAILED DESCRIPTION OF THE INVENTION

Reference is made herein to the attached drawings. Like reference numerals are used throughout the drawings to depict like or similar elements of the sprinkler sleeve attachment. For the purposes of presenting a brief and clear description of the present invention, the preferred embodiment will be discussed as used for providing a sprinkler head housing which allows for the sprinkler head to easily and conveniently be taken out and replaced. The figures are intended for representative purposes only and should not be considered to be limiting in any respect.

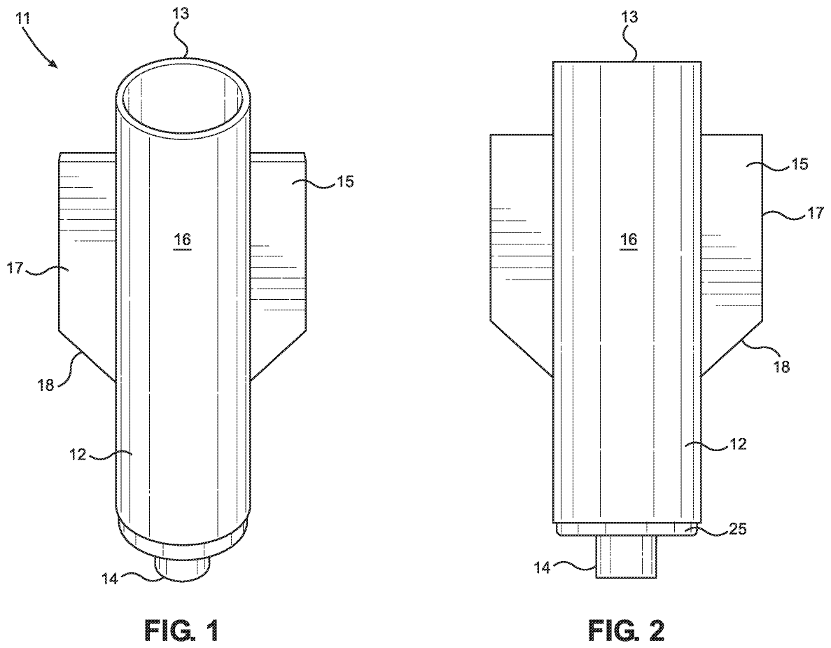

Referring now to FIG. 1 and FIG. 2, there is shown a perspective view of an embodiment of the sprinkler sleeve attachment and a side view of an embodiment of the sprinkler sleeve attachment, respectively. In the illustrated embodiment, the sprinkler sleeve attachment 11 comprises a unitary body 12 having a tubular cross-section, however alternate cross-sections are contemplated. The unitary construction of the unitary body 12 ensures that the sprinkler sleeve attachment 11 is easily installed and removed, requiring minimal effort on the part of the user, while maximizing efficiency. The unitary body 12 further comprises an open top end 13 and an open bottom end 14 defining a channel having an interior volume therethrough. In the illustrated embodiment, the diameter of the open top end 13 is greater than the diameter of the open bottom end 14, such that the unitary body 12 tapers down to the open bottom end 14. In some embodiments, the unitary body 12 comprises a rigid and durable material such that it will not deform under pressure, thereby ensuring the structural integrity of the unitary body 12 is maintained during use, such as when buried underground. In one embodiment of the sprinkler sleeve attachment 11, the elongated body 12 consists of a synthetic polymer material such as plastic but may comprise any suitable material.

A plurality of stabilizing fins 15 are disposed on an exterior surface 16 of the unitary body 12. The stabilizing fins 15 protrude outwardly from the unitary body 12 and terminate at a distal edge 17. In the illustrated embodiment, the stabilizing fins 15 comprise an elongated and planar dimension running along the longitudinal axis of the unitary body 12 from the open top end 13 towards the open bottom end 14. In this way, the plurality of stabilizing fins 15 are configured to prevent rotational movement of the sprinkler sleeve attachment 11 during use, ensuring that the sprinkler sleeve attachment 11 remains anchored within the ground. In the illustrated embodiment of the sprinkler sleeve attachment 11, a taper 18 in the stabilizing fin 15 is included toward the open bottom end 14 such that each of the plurality of stabilizing fins 15 descends downward from the distal edge 17 until terminating at the exterior surface 16 of the unitary body 12 at a point proximal to the open bottom end 14. The taper 18 allows the sprinkler sleeve attachment 11 to pierce the ground surface more easily when installed, minimizing the amount of digging required before installation thereof. In the illustrated embodiment, the plurality of stabilizing fins 15 comprise two fins 15 disposed at opposing points of the exterior surface 16 of the unitary body 12, such that the plurality of stabilizing fins 15 are coplanar. In this way, the sprinkler sleeve attachment 11 is more securely anchored within the ground surface.

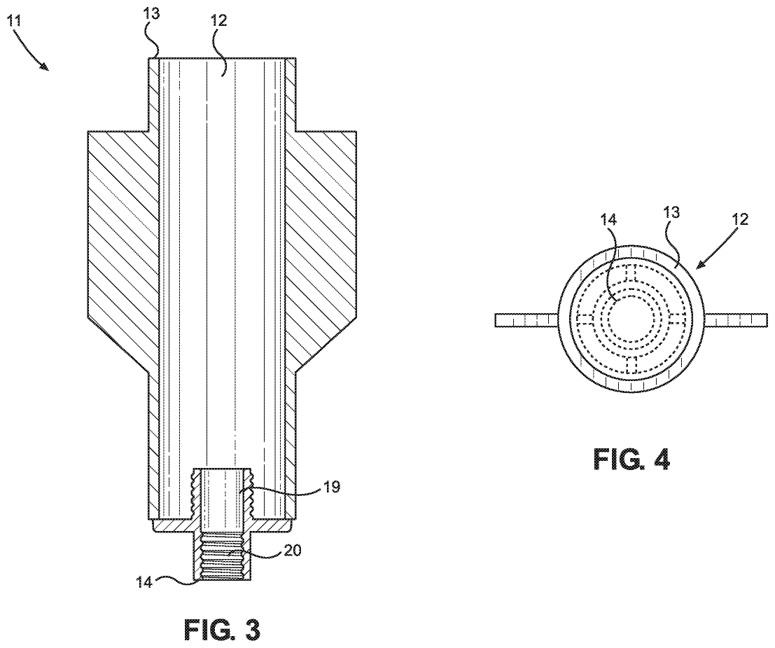

Referring now to FIG. 3 and FIG. 4, there is shown a cross-sectional view of an embodiment of the sprinkler sleeve attachment and an overhead view of an embodiment of the sprinkler sleeve attachment, respectively. An internal connection member 19 is included within the interior volume of the unitary body 12. In the illustrated embodiment, the internal connection member 19 comprises an externally threaded male adaption centrally located within the channel of the unitary body 12 toward the open bottom end 14. The internal connection member 19 is configured to removably secure a sprinkler head thereon. An external connection member 20 is disposed on the open bottom end 14 of the unitary body 12. In the illustrated embodiment, the external connection member 20 comprises an internally threaded female adaption configured to removably receive a water connection line therein. In the illustrated embodiment, the internal and external connection members 19, 20 coaxially align with one another and define an open channel therethrough such that a water connection line and sprinkler head removably installed within their respective connection members 19 and 20 may operate in fluid connection with one another.

In the illustrated embodiment, the unitary body 12 comprises a circular cross-sectional area of tubular construction which defines a cylindrical interior volume within. The interior volume is dimensioned such that a sprinkler head may be received therein and installed on the internal connection member 19. When installed in such a manner, the working end of a sprinkler head will rest flush against the outer rim of the open top end 13 and extend outward therefrom. In this way, the user can simply remove the sprinkler head from the unitary body 12 by grasping the working end, allowing a user to easily interchange sprinkler heads within the sprinkler sleeve attachment 11.

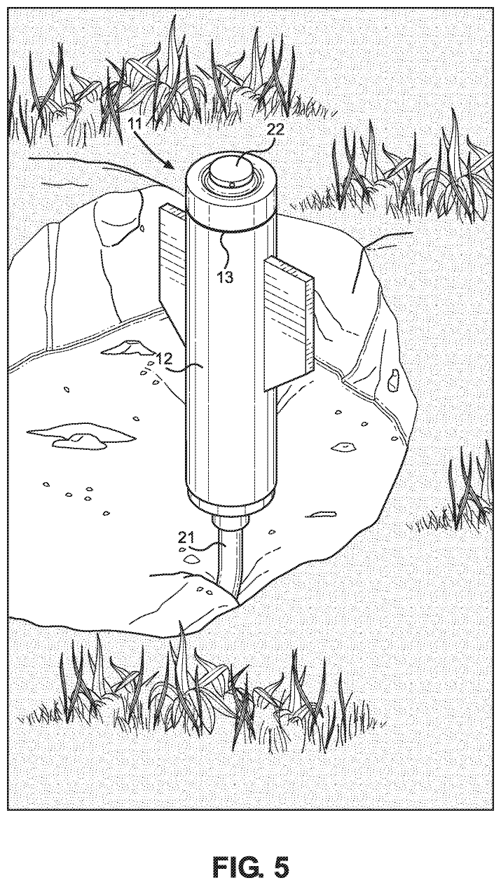

Referring now to FIG. 5, there is shown a perspective view of an embodiment of the sprinkler sleeve attachment in use. In use, the sprinkler sleeve attachment 11 is installed on an end of an in-ground water connection line 21 via the external connection member. The entire sprinkler sleeve attachment 11 may then be backfilled around it such that the ground level reaches nearly to the rim of the open top end 13, keeping clear the interior volume of the unitary body 12. The stabilizing fins disposed on the exterior surface of the unitary body 12 help keep the sprinkler sleeve attachment 11 from shifting around in the soil so that the open top end 13 protrudes out of the ground surface at the desired angle. A sprinkler head 22 may then be installed within the interior volume of the unitary body 12 using the internal connection member such that the sprinkler head 22 is in fluid communication with the water connection line 21 when activated. In the illustrated embodiment, the sprinkler head 22 rests flush against the open upper end 13, thereby forming a seal to ensure that soil does not seep into the interior volume when the sprinkler head 22 is installed. Furthermore, in the illustrated embodiment, the unitary body 12 is dimensioned to match a diameter of the sprinkler head 22, such that an exterior surface of the sprinkler head 22 is aligned with the exterior surface of the unitary body 12. In this way, the user can easily gauge the placement and orientation of the sprinkler sleeve attachment 11 within the ground surface, allowing adjustments to be made if the ground shifts the sprinkler sleeve attachment 11 from a desired position. If a sprinkler head 22 becomes damaged or otherwise needs to be replaced, a user may then easily uninstall the sprinkler head 22 from the interior volume and insert a new sprinkler head 22. This can be done with minimal effort and without the requirement of excavating the surrounding soil down to the existing water connection line 21, thereby saving time and expense.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A sprinkler sleeve attachment, comprising:
a unitary body having an open upper end and an open lower end defining a channel therethrough, wherein the diameter of the lower end is smaller than that of the upper end;
an internal connection member within the unitary body;
an external connection member disposed on the open lower end;
an annular shoulder disposed between the external connection member and the lower end of the unitary body;
a plurality of stabilizing fins running longitudinally along an exterior surface of the unitary body, wherein a width of each stabilizing fin of the plurality of stabilizing fins tapers inwardly from an upper end of each stabilizing fin to a lower end of each stabilizing fin;
wherein an upper end of each stabilizing fin terminates beneath an upper edge of the unitary body, and wherein a lower end of each stabilizing fin terminates above a lower edge of the unitary body;
wherein the channel is configured to receive a sprinkler head such that an outer wall of the sprinkler head aligns flush with an exterior surface of the unitary body.

2) (canceled)

3) The sprinkler sleeve attachment of claim 1, wherein the unitary body has a circular cross-sectional area.

4) The sprinkler sleeve attachment of claim 1, wherein the internal connection comprises a tubular threaded male adaption to receive an end of a sprinkler head thereon in liquid communication.

5) The sprinkler sleeve attachment of claim 1, wherein the external connection comprises a threaded female adaption to receive an end of a water line connection therein in liquid communication.

6) The sprinkler sleeve attachment of claim 1, wherein the plurality of stabilizing fins comprise planar protrusions extending orthogonally outward from the exterior surface of the unitary body and terminate in a distal edge.

7) The sprinkler sleeve attachment of claim 6, wherein the plurality of stabilizing fins are symmetrical.

8) The sprinkler sleeve attachment of claim 6, wherein the plurality of stabilizing fins are included on the exterior surface of the unitary body on opposing sides thereof.

9) The sprinkler sleeve attachment of claim 1, wherein the internal connection member and external connection member comprise a tubular construction aligned along their longitudinal axis creating a channel therethrough.

10) The sprinkler sleeve attachment of claim 9, wherein the internal connection member and the external connection member are in fluid communication with one another.

11) A sprinkler sleeve attachment, comprising:
a unitary body having an open upper end and an open lower end defining a channel therethrough, wherein the diameter of the lower end is smaller than that of the upper end;
an internal connection member within the unitary body;
an external connection member disposed on the open lower end;
an annular shoulder disposed between the external connection member and the lower end of the unitary body, the annular shoulder including a diameter that is less than a diameter of the unitary body and greater than a diameter of the external connection member;
a plurality of stabilizing fins running longitudinally along an exterior surface of the unitary body;
wherein the plurality of stabilizing fins comprises a pair of coplanar stabilizing fins;
wherein an upper end of each stabilizing fin terminates beneath an upper edge of the unitary body, and wherein a lower end of each stabilizing fin terminates above a lower edge of the unitary body;
wherein the channel is configured to receive a sprinkler head such that an outer wall of the sprinkler head aligns flush with an exterior surface of the unitary body.

12) (canceled)

13) The sprinkler sleeve attachment of claim 1, wherein the unitary body has a circular cross-sectional area.

14) The sprinkler sleeve attachment of claim 1, wherein the internal connection comprises a tubular threaded male adaption to receive an end of a sprinkler head thereon in liquid communication.

15) The sprinkler sleeve attachment of claim 1, wherein the external connection comprises a threaded female adaption to receive an end of a water line connection therein in liquid communication.

16) The sprinkler sleeve attachment of claim 1, wherein the plurality of stabilizing fins comprise planar protrusions extending orthogonally outward from the exterior surface of the unitary body and terminate in a distal edge.

17) The sprinkler sleeve attachment of claim 6, wherein the plurality of stabilizing fins are symmetrical.

18) The sprinkler sleeve attachment of claim 6, wherein the plurality of stabilizing fins are included on the exterior surface of the unitary body on opposing sides thereof.

19) The sprinkler sleeve attachment of claim 1, wherein the internal connection member and external connection member comprise a tubular construction aligned along their longitudinal axis creating a channel therethrough.

20) The sprinkler sleeve attachment of claim 9, wherein the internal connection member and the external connection member are in fluid communication with one another.
